(19) United States
(12) Patent Application Publication
(10) Pub. No.: US 2024/0281281 A1
(43) Pub. Date: Aug. 22, 2024

(54) NEURAL NETWORK ACCELERATOR AND METHOD OF CONTROLLING SAME

(71) Applicant: UIF (University Industry Foundation), Yonsei University, Seoul (KR)

(72) Inventors: William Jinho SONG, Seoul (KR); Hyeonjin KIM, Seoul (KR)

(73) Assignee: UIF (University Industry Foundation), Yonsei University, Seoul (KR)

(21) Appl. No.: 18/435,422

(22) Filed: Feb. 7, 2024

(30) Foreign Application Priority Data
Feb. 17, 2023 (KR) 10-2023-0021603
Nov. 28, 2023 (KR) 10-2023-0168450

(51) Int. Cl. G06F 9/48; G06F 9/50

(52) U.S. Cl. CPC G06F 9/4881; G06F 9/5027

(57) ABSTRACT

The disclosure includes a memory storing at least one instruction, and at least one processor configured to execute the at least one instruction stored in the memory, wherein the at least one processor executes the at least one instruction to identify a first array of a plurality of data tiles constituting an unfolded input tensor obtained by unfolding an input tensor to perform a convolution operation by using a general matrix multiplication (GEMM) operation, identify a tile distance indicating a distance between a pair of data tiles with highest data similarity among the plurality of data tiles in the first array, form a plurality of data tile sets by grouping the plurality of data tiles based on the tile distance, and allocate the plurality of data tile sets to a plurality of components that process the general matrix multiplication operation in parallel.

### CROSS-REFERENCE TO RELATED APPLICATION

This application is based on and claims priority under 35 U.S.C. § 119 to Korean Patent Application Nos. 10-2023-0021603, filed on Feb. 17, 2023, and 10-2023-0168450, filed on Nov. 28, 2023, in the Korean Intellectual Property Office, the disclosures of which are incorporated by reference herein in their entireties.

### BACKGROUND

### 1. Field

The disclosure relates to a technology on a neural network accelerator, and more particularly, to a neural network accelerator that performs locality-aware scheduling and a method of controlling the neural network accelerator.

### 2. Description of the Related Art

A deep neural network (DNN) is an essential element of various applications due to excellent accuracy and versatility, such as image classification and object detection.

Because a convolution operation according to a convolution layer takes up the majority of the total execution time of a DNN, technology for accelerating the convolution operation is required.

### SUMMARY

Additional aspects will be set forth in part in the description which follows and, in part, will be apparent from the description, or may be learned by practice of the presented embodiments of the disclosure.

According to an aspect of the disclosure, a scheduling method of a neural network accelerator includes identifying a first array of a plurality of data tiles constituting an unfolded input tensor obtained by unfolding an input tensor to perform a convolution operation by using a general matrix multiplication (GEMM) operation. In one embodiment, the method may include identifying a tile distance indicating a distance between a pair of data tiles with highest data similarity among the plurality of data tiles in the first array. In one embodiment, the method may include forming a plurality of data tile sets by grouping the plurality of data tiles based on the tile distance. In one embodiment, the method may include allocating the plurality of data tile sets to a plurality of components that process the GEMM operation in parallel.

According to another aspect of the disclosure, a neural network accelerator includes a memory storing at least one instruction, and at least one processor configured to execute the at least one instruction stored in the memory. In one embodiment, the at least one processor may execute the at least one instruction to identify a first array of a plurality of data tiles constituting an unfolded input tensor obtained by unfolding an input tensor to perform a convolution operation by using a general matrix multiplication (GEMM) operation. In one embodiment, the at least one processor may identify a tile distance indicating a distance between a pair of data tiles with highest data similarity among the plurality of data tiles in the first array. In one embodiment, the at least one processor may form a plurality of data tile sets by grouping the plurality of data tiles based on the tile distance. In one embodiment, the at least one processor may allocate the plurality of data tile sets to a plurality of components that process the general matrix multiplication operation in parallel.

According to another aspect of the disclosure, a computer-readable recording medium, on which a program for performing at least one method of scheduling the disclosed neural network accelerator by a computer is recorded, is provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a method of performing, by a neural network accelerator, a convolution operation by using a general matrix multiplication (GEMM) operation, according to an embodiment;

FIG. 2 is a flowchart illustrating a scheduling method of a neural network accelerator, according to an embodiment;

FIGS. 3A and 3B are diagrams illustrating a tile distance according to an embodiment;

FIGS. 4A and 4B are diagrams illustrating an operation of a neural network accelerator to identify a second array, according to an embodiment;

FIGS. 5A and 5B are diagrams illustrating an operation of a neural network accelerator to form a data tile set, according to an embodiment;

FIG. 6 is a diagram illustrating an operation of a neural network accelerator to allocate a data tile set to a component, according to an embodiment;

FIG. 7A is pseudocode illustrating an algorithm for forming a data tile set by a neural network accelerator, according to an embodiment;

FIG. 7B is a diagram illustrating a second array of a plurality of data tiles identified by a neural network accelerator while switching a scan direction, according to an embodiment;

FIG. 7C is pseudocode illustrating an algorithm for allocating data tile sets to a plurality of components by a neural network accelerator, according to an embodiment;

FIG. 8 is a diagram illustrating similarity of data tiles allocated to components according to scheduling of a neural network accelerator according to an embodiment;

FIGS. 9A and 9B are diagrams illustrating memory addresses accessed by components according to scheduling of a neural network accelerator according to an embodiment; and

FIG. 10 is a diagram illustrating a detailed configuration of a neural network accelerator according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, details for implementing the disclosure are described in detail with reference to the attached drawings. However, in the following description, detailed descriptions of well-known functions or configurations are omitted when there is a risk of unnecessarily obscuring the gist of the disclosure.

In the accompanying drawings, identical or corresponding components are given the same reference numerals. Also, in the description of the following embodiments, redundant descriptions of identical or corresponding components may be omitted. However, even when descriptions of components are omitted, it is not intended that such components are not included in any embodiment.

Advantages and features of the disclosed embodiments and methods for achieving the advantages and features will become clear by referring to the embodiments described below with reference to the accompanying drawings. However, the disclosure is not limited to the embodiments disclosed below and may be implemented in various different forms, and the present embodiments are merely provided to ensure that the disclosure is complete and provided solely to fully convey the scope of the disclosure to those skilled in the art.

Terms used in the present specification will be briefly described, and the disclosed embodiments will be described in detail. The terms used in the present specification are general terms that are currently widely used as much as possible while considering the function in the disclosure, but this may change depending on the intention or precedent of a technician working in the related field, the emergence of new technology, and so on. Also, in certain cases, there are terms randomly selected by the applicant, and in this case, the meaning will be described in detail in the description relevant to the disclosure. Therefore, the terms used in the disclosure should be defined based on the meaning of the term and the entire content of the disclosure, rather than simply the names of the terms.

In the present specification, singular expressions include plural expressions, unless the context clearly specifies the singular expressions. Also, plural expressions include singular expressions, unless the context clearly specifies plural expressions. When it is described that a portion “includes” a certain component throughout the specification, this does not mean excluding other elements but may further include other elements, unless specifically stated to the contrary.

In the present specification, a “Neural Network” is a representative example of an artificial neural network model that simulates brain nerves and is not limited to an artificial neural network model using a specific algorithm. In one embodiment, a neural network may also be referred to as a deep neural network.

In the present specification, a “neural network accelerator” may refer to a processor specifically optimized to process deep neural network workloads or an electronic device including the processor. In one embodiment, a neural network accelerator may also be referred to as a deep neural network accelerator.

In the present specification, “neural network data” may refer to data required for a neural network accelerator to perform a convolution operation or perform scheduling. The neural network data may be received from an external electronic device or obtained based on a user input. In one embodiment, the neural network data may include an input tensor, a filter tensor, and an output tensor on which a convolution operation is performed.

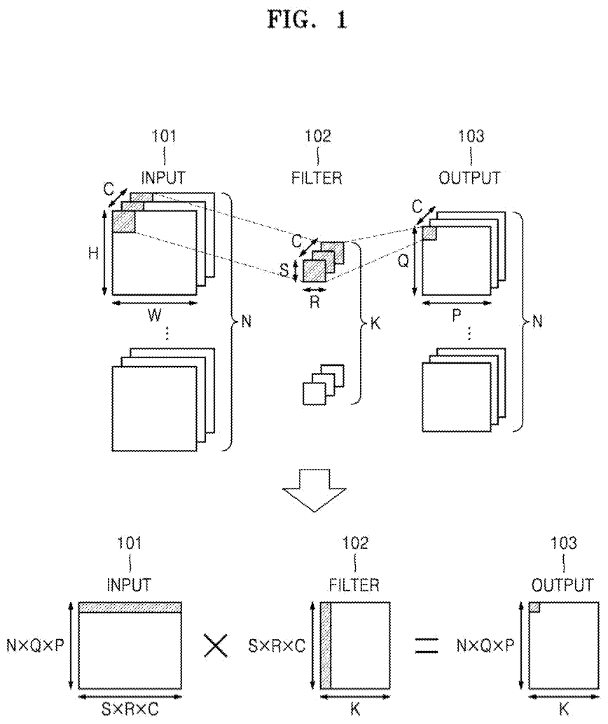

FIG. 1 is a diagram illustrating a method of performing, by a neural network accelerator, a convolution operation by using a general matrix multiplication (GEMM) operation, according to an embodiment.

Referring to FIG. 1, the neural network accelerator may perform a convolution operation on neural network data. The neural network data on which a convolution operation is performed may include an input tensor 101, a filter tensor 102, and an output tensor 103. In one embodiment, the neural network accelerator may perform a convolution operation between the input tensor 101 and the filter tensor 102 to obtain the output tensor 103. The convolution operation may mean that, while the filter tensor 102 slides over the input tensor 101, multiplication is performed between elements of the input tensor 101 where the filter tensor 102 is located, and elements of the filter tensor 102, and a plurality of elements constituting the output tensor 103 are calculated by adding up the multiplication result.

In one embodiment, the neural network accelerator may perform a convolution operation on the neural network data by using a GEMM operation. Here, performing a convolution operation by using a GEMM operation may be referred to as a GEMM-based convolution operation. In one embodiment, the neural network accelerator may obtain an unfolded filter tensor by performing matrix multiplication between the unfolded input tensor 102 obtained by unfolding the input tensor 101 through GEMM-based convolution operation and the unfolded filter tensor 112 obtained by unfolding the filter tensor 120. Because a plurality of elements constituting the unfolded output tensor 113 each correspond to a plurality of elements constituting the output tensor 130, the neural network accelerator may perform a convolution operation by using the GEMM operation.

In one embodiment, the unfolded input tensor 111 may include overlapping elements. The overlapping elements may mean elements that are duplicated from the same element of the input tensor 101 and have the same values. That is, in a process of unfolding the input tensor 101 to obtain the unfolded input tensor 111, the elements constituting the input tensor 101 may be duplicated as different elements of the unfolded input tensor 111, and the overlapping elements may have the same value because the overlapping elements are duplicated from the same element of the unfolded input tensor 101.

In one embodiment, the neural network accelerator may include a plurality of components that perform a GEMM operation. In one embodiment, the plurality of components may include a plurality of operational units for performing the GEMM operation. In one embodiment, the neural network accelerator may perform the GEMM operation in parallel by allocating a plurality of data tiles constituting an unfolded tensor to a plurality of components. In one embodiment, a data tile may mean a part of an unfolded tensor formed by dividing the unfolded tensor into preset sizes. In one embodiment, the plurality of components may receive data corresponding to the allocated data tile from an external memory of the plurality of components and store the data in an internal memory of the plurality of components. In one embodiment, the plurality of components may perform a GEMM operation on the data tile stored in the internal memories and then transfer the results to the external memory.

In one embodiment, the GEMM-based convolution operation of the neural network accelerator may be performed by using an explicit GEMM method or an implicit GEMM method.

In one embodiment, the explicit GEMM method may refer to a method of performing a GEMM operation by unfolding a tensor on which a convolution operation is performed to a workspace of the external memory of the plurality of components. According to the explicit GEMM method, the unfolded tensor is allocated to and stored in a workspace of an external memory, and a plurality of data tiles constituting the unfolded tensor stored in the workspace of the external memory are allocated to a plurality of components to perform a GEMM operation.

In one embodiment, the implicit GEMM method may refer to a method of performing a GEMM operation by unfolding a tensor on which a convolution operation is performed to a workspace of an internal memory of a plurality of components. According to the implicit GEMM method, when a data tile is allocated to a plurality of components, the elements corresponding to the allocated data tile among the plurality of elements of the tensor, on which the convolution operation is performed, stored in the external memory of the plurality of components are loaded into the internal memory of the plurality of components. The plurality of components may store the data tiles allocated to the components in the internal memory based on the loaded elements and perform a GEMM operation on the stored data tiles.

In one embodiment, the internal memory of the plurality of components may include a cache memory and a main memory. In one embodiment, the cache memory may refer to an internal memory structure or internal memory space in which a plurality of elements of data tiles allocated to a plurality of components are temporarily stored before being stored in the main memory. In one embodiment, the main memory may refer to an internal memory structure or internal memory space where a plurality of data tiles, in which GEMM operations of a plurality of components are performed, are stored. In one embodiment, the cache memory may have a structure different from the main memory, or a region to which the cache memory is allocated and a region to which the main memory is allocated are respectively set in an internal memory of a single structure.

In one embodiment, when a data tile is allocated to a component, the component may load a plurality of elements corresponding to the allocated data tile stored in an external memory through a cache memory of an internal memory. The plurality of elements loaded into the cache memory may be stored in the main memory as allocated data tiles on which a GEMM operation is performed. In one embodiment, the elements previously stored in the cache memory among the plurality of elements of the data tiles allocated to the component are not loaded into the cache memory from an external memory, and the elements previously stored in the cache memory are stored in the main memory, and thereby, data tiles on which a GEMM operation is performed may be stored in the main memory. In this case, because the component obtains a plurality of elements corresponding to the allocated data tile from the cache memory other than an external memory, the time and cost required for the component to access the external memory for a GEMM operation may be reduced.

According to an embodiment, when performing a convolution operation by using the implicit GEMM method, the neural network accelerator may group data tiles with high data similarity and allocate the data tiles to a plurality of components. In this way, a scheduling method, by which similar data tiles with high data similarity are grouped and allocated to a plurality of components, may be referred to as locality-aware scheduling. Because the data tiles grouped through locality-aware scheduling include many identical overlapping elements generated by duplicating the same element, utilization of cache memory of a plurality of components may be increased. Also, because the dependence on the size of cache memory of the plurality of components is reduced, a size of the main memory of the plurality of components may be increased. Accordingly, parallel processing performance by a plurality of components may be increased.

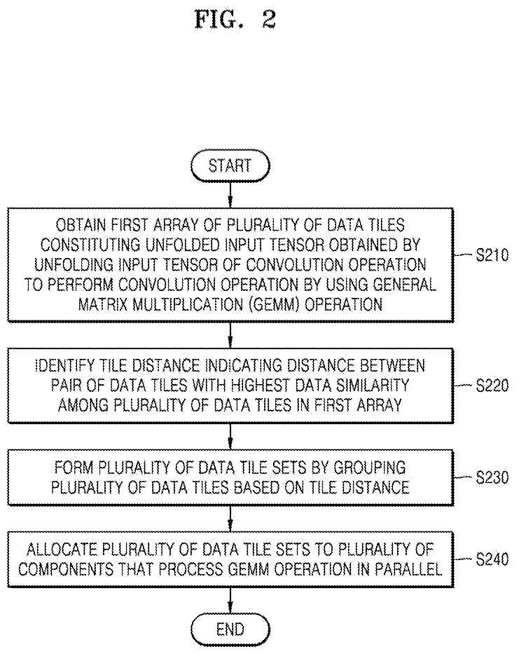

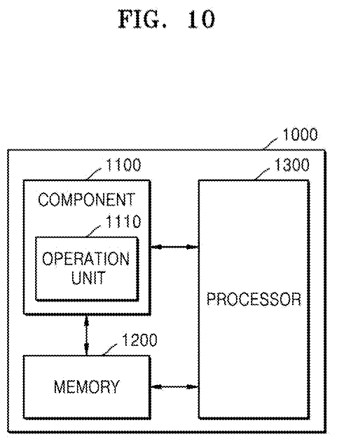

FIG. 2 is a flowchart illustrating a scheduling method of a neural network accelerator, according to an embodiment. Scheduling of a neural network accelerator may be performed by a scheduler included in the neural network accelerator. In one embodiment, the scheduler may be implemented by hardware or software of a neural network accelerator or may be implemented by a combination of hardware and software. Also, the operation of a neural network accelerator illustrated in FIG. 2 may be performed by the neural network accelerator 1000 illustrated in FIG. 10 or at least one processor 1300 of the neural network accelerator 1000.

In operation S210, the neural network accelerator may identify a first array of a plurality of data tiles constituting the unfolded input tensor obtained by unfolding the input tensor of a convolution operation to perform the convolution operation by using a GEMM operation.

In one embodiment, the plurality of data tiles may refer to a part of the unfolded tensor formed by dividing the unfolded tensor into preset sizes. In one embodiment, the unfolded input tensor is grid-divided into a preset size, thereby forming a plurality of data tiles. In one embodiment, as the unfolded input tensor is divided into a plurality of data tiles, an array of a plurality of data tiles including rows and columns may be formed.

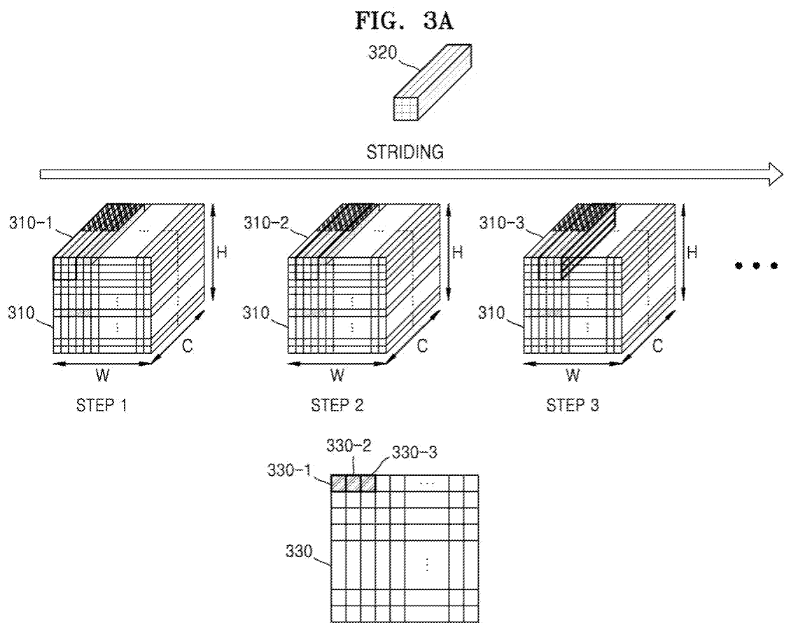

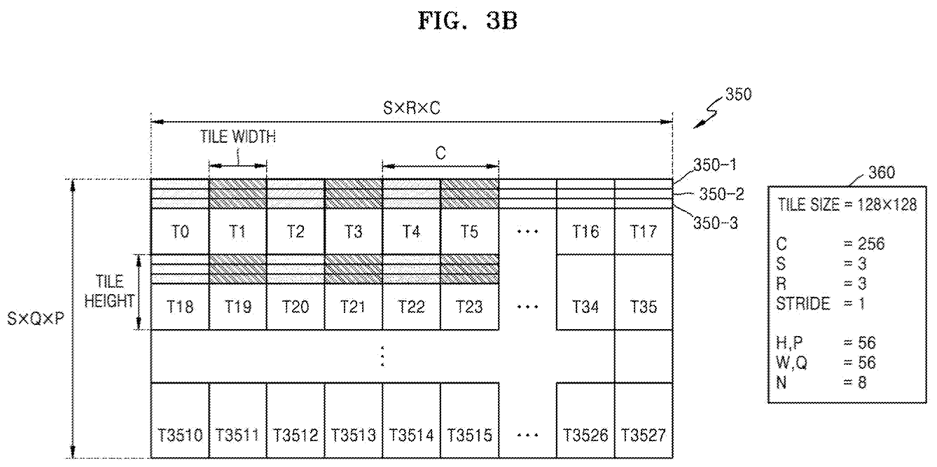

In one embodiment, the unfolded input tensor is a two-dimensional tensor obtained based on arranging a plurality of elements of the input tensor, on which element-by-element multiplication is performed at each step of a convolution operation, as elements of each row of the unfolded input tensor. Details about the unfolded input tensor are described below again with reference to FIGS. 3A and 3B.

In one embodiment, a neural network accelerator may identify a first array of a plurality of data tiles constituting the unfolded input tensor based on information on a convolution parameter of neural network data and a data tile size. That is, the neural network accelerator may identify the first array of the plurality of data tiles constituting the unfolded tensor without unfolding the input tensor to obtain the unfolded input tensor.

In one embodiment, the convolution parameter may include information on the dimension or size of tensors on which a convolution operation is performed. For example, the convolution parameter may include information on a width, a height, the number of channels, a batch size, a stride, and so on of tensors on which a convolution operation is performed, and is not limited to the examples described above.

In one embodiment, the neural network accelerator may obtain information on a size of the unfolded input tensor based on the convolution parameter. In one embodiment, the neural network accelerator may identify the number of data tiles divided in a row direction and the number of data tiles divided in a column direction from the unfolded input tensor based on information on the size of the unfolded input tensor and information on the size of the data tiles.

In one embodiment, the neural network accelerator may identify a first array of a plurality of data tiles constituting an unfolded tensor based on the number of data tiles divided in a row direction and the number of data tiles divided in a column direction from the unfolded input tensor. For example, the neural network accelerator may identify the data tiles as being divided into 18 rows and divided into 196 columns in the unfolded input tensor based on the information in the unfolded input tensor is 2304×25088 in size and the data tile is 128×128 in size, and may identify that an array of a plurality of data tiles having a size of 18×196 is formed.

In one embodiment, the sizes of the plurality of data tiles constituting the unfolded input tensor may be set to maximize the utilization of the plurality of components. For example, when a component may perform a GEMM operation on data tiles of the unfolded input tensor having a size of up to 128 KB in size at a time, the size of the data tiles may be set to 128 KB to maximize the utilization of the component. However, the disclosure is not limited to the example described above, and sizes of a plurality of data tiles may be set based on a user input for setting the size of the data tiles and/or hardware specification of a neural network accelerator.

In operation S220, the neural network accelerator may identify a tile distance indicating a distance between a pair of data tiles with the highest data similarity among a plurality of data tiles in the first array.

In one embodiment, data similarity may refer to a degree to which different data tiles include the same overlapping elements. For example, the more the different data tiles include the same overlapping elements, the higher the data similarity, and the less the different data tiles include the same overlapping elements, the lower the data similarity. In one embodiment, there may be a plurality of data tiles with data similarity based on a certain data tile, and the data tile including the most overlapping elements identical to the overlapping elements included in the certain data tile may be a data tile with the highest data similarity to the certain data tile. In one embodiment, data tiles with data similarity may be referred to as similar data tiles.

In one embodiment, a distance between different data tiles in the first array may refer to a value indicating how far apart two data tiles in the first array are in a row direction. For example, a distance between a data tile of number 0 at (1,1) in the first array and a data tile of number 2 at (1,3) of the first array is 2, and a distance between a data tile of number 0 and a data tile of number 4 at (1,5) in the first array may be 4, and the disclosure is not limited to the example described above.

In one embodiment, the neural network accelerator may identify a value obtained by dividing another value, which is obtained by multiplying the number of channels of an input tensor by a stride of a filter tensor of a convolution operation, by a width of each of a plurality of data tiles, as the tile distance. For example, when the number of channels of the input tensor is 256 and the stride of the filter tensor is 1 and the width of the data tile is 128, the neural network accelerator may identify the tile distance as (256×1)/128=2, and the disclosure is not limited to the example described above.

In operation S230, the neural network accelerator may form a plurality of data tile sets by grouping a plurality of data tiles based on the tile distance. In one embodiment, the plurality of data tile sets may be mapped with data tiles included in the plurality of data tile sets and stored in a data tile set pool.

In one embodiment, the neural network accelerator may identify a plurality of second arrays of a plurality of data tiles by grouping data tiles that are spaced apart by a tile distance from the first array. Here, grouping data tiles spaced apart by the tile distance may mean performing grouping such that another data tile at a tile distance away from the certain data tile is included in the same group as the certain data tile based on the certain data tile in the first array.

In one embodiment, the neural network accelerator may identify a plurality of second arrays such that data tiles in the same column in the first array are included in the same second array. That is, the neural network accelerator may identify a plurality of second arrays by grouping data tiles spaced apart by a tile distance in a row direction for each of a plurality of rows in the first array, and grouping data tiles in the same column into the same group.

In one embodiment, the neural network accelerator may form a plurality of data tile sets by grouping data tiles included in each of the plurality of second arrays. That is, because the plurality of data tile sets are formed from each of the plurality of second arrays, each data tile set may not include data tiles included in the second arrays different from each other.

In one embodiment, the neural network accelerator may form a plurality of data tile sets by grouping adjacent data tiles by a preset number for each group in each of the plurality of second arrays.

In one embodiment, the neural network accelerator may group adjacent data tiles in a row direction by a preset number for each group in each of the plurality of second arrays. In one embodiment, the neural network accelerator may group, by a preset number for each group, the data tiles which are obtained by adding at least one data tile that is not grouped by the preset number in a row direction in each of the plurality of second arrays to at least one data tile adjacent to the ungrouped data tiles in a column direction.

In one embodiment, the preset number may be determined based on the number of data tiles that may be simultaneously allocated to each of a plurality of components. In one embodiment, the number of data tiles that may be simultaneously allocated to a plurality of components may be limited based on the size of an internal memory. For example, when the size of a main memory to which the data tile on which the GEMM operation is performed in the internal memory of a plurality of components is allocated is 96 KB, and when a size of the data tile is 32 KB, maximum 3 data tiles may be allocated to the plurality of components. In this case, the neural network accelerator may determine the preset number as the number of data tiles that may be simultaneously allocated to each of a plurality of components. However, the disclosure is not limited to the example described above, and the preset number may also be determined as a certain number less than or equal to the number of data tiles that may be simultaneously allocated to each of a plurality of components.

In operation S240, the neural network accelerator may allocate a plurality of data tile sets to a plurality of components that process a GEMM operation in parallel. In one embodiment, a data tile allocated to a component may be stored in an internal memory of the component, and accordingly, a GEMM operation may be performed by the component. That is, similar data tiles among a plurality of data tiles may be grouped into a data tile set and allocated to each of a plurality of components, and thereby, a GEMM operation may be performed.

In one embodiment, the neural network accelerator may identify a component of which queue is empty among a plurality of components. In one embodiment, a list of data tile sets allocated to a component may be stored in a queue of a component. In one embodiment, a data tile allocated to a component among data tiles included in a data tile set registered in a queue may be removed from the queue of the component. In one embodiment, a neural network accelerator may identify that a queue of a component is empty when all data tiles included in a data tile set registered in the queue are allocated to the component.

In one embodiment, a neural network accelerator may register one of a plurality of data tile sets in a queue of the identified component. In one embodiment, a neural network accelerator may register one of a plurality of data tile sets stored in a data tile set pool in a queue of an identified component, and may remove the registered data tile set from the data tile set pool.

In one embodiment, when a GEMM operation on a data tile allocated to an identified component is completed, a neural network accelerator may allocate a data tile included in a registered data tile set to an identified component. In one embodiment, an identified component may perform a GEMM operation on a previously allocated data tile, and once the GEMM operation on the previously allocated data tile is completed, the identified component may perform the GEMM operation on a new data tile. In one embodiment, when an identified component may perform a GEMM operation on a new data tile, a data tile included in a data tile set registered in a queue may be allocated to the identified component, and the identified component may perform a GEMM operation on the newly allocated data tile.

FIGS. 3A and 3B are diagrams illustrating a tile distance according to an embodiment.

Referring to FIG. 3A, a neural network accelerator may obtain an output tensor 330 by performing a convolution operation between an input tensor 310 and a filter tensor 320. For the sake of convenience of description of the disclosure, FIG. 3A illustrates that a batch size N of each of the input tensor 310 and the output tensor 330 is 1 and the number N of filter tensors is 1, but a value of an actual convolution parameter may be set to be different thereto.

In one embodiment, the filter tensor 320 may stride over the input tensor 310 at each step of a convolution operation and element-by-element multiplication is performed, and a neural network accelerator may sum results of the multiplication and obtain a plurality of elements of the output tensor 330. For example, the neural network accelerator may multiply a plurality of elements 310-1 of the input tensor 310 in a first position, a plurality of elements 310-2 of the input tensor 310 in a second position, and a plurality of elements 310-3 of the input tensor 310 in a third position by a plurality of elements of the filter tensor 320, sum the multiplication results, and thereby obtaining a first element 330-1, a second element 330-2, and a third element 330-3 of the output tensor 330. In one embodiment, because some of the plurality of elements 310-1 in the first position may be included in the plurality of elements 310-2 in the second position and the plurality of elements 310-3 in the third position, an element-by-element operation on the same elements may be performed repeatedly in each step of a convolution operation.

Referring to FIG. 3B, when a neural network accelerator unfolds the input tensor 310 to perform a convolution operation as a GEMM operation, an unfolded input tensor 350 may be obtained.

In one embodiment, a plurality of elements constituting each row of the unfolded input tensor 350 may be a plurality of elements of the input tensor 320 on which element-by-element multiplication is performed with the filter tensor 310 in each step of the convolution operation of FIG. 3A. For example, a plurality of elements 350-1 of the unfolded input tensor 350 in a first row, a plurality of elements 350-2 of the unfolded input tensor 350 in a second row, and a plurality of elements 350 of the unfolded input tensor 350 in a third row may be respectively the plurality of elements 310-1 of the input tensor 310 in the first position, the plurality of elements 310-2 of the input tensor 310 in the second position, and the plurality of elements 310-3 of the input tensor 310 in the third position.

In one embodiment, a plurality of elements constituting each row of the unfolded input tensor 350 may be arranged in the input tensor 350 in which a plurality of elements of the filter tensor 320 that are element-by-element-multiplied by the filter tensor 320 are selected and unfolded sequentially along a channel axis in each step of a convolution operation. For example, among the plurality of elements 310-1 in the first position, a plurality of elements in the first channel to the last channel of a first row and a first column are sequentially indexed, and a plurality of elements in the first channel to the last channel of the first row and a second column are sequentially indexed, and thereby, the plurality of elements 350-1 in the first row may be arranged. In one embodiment, when a batch size of the input tensor 310 is 2 or more, after indexing of a batch in a previous order of the input tensor 310 is completed, indexing of a batch in a next order is performed, and thereby, the unfolded input tensor 350 may be formed.

In one embodiment, a neural network accelerator may identify a first array of a plurality of data tiles constituting the unfolded input tensor 350. For example, the neural network accelerator may obtain information on a two-dimensional tensor including a data tile which is unfolded based on information 360 on a convolution parameter and data tile size and has a height of N×Q×P=25,088 and a width of S×R×C=2,304, and may identify a first array of a plurality of data tiles in the form of 18×196 formed when the unfolded input tensor 350 is divided into data tile having a width of 128 and a height of 128.

In one embodiment, a neural network accelerator may identify a tile distance representing a distance between a pair of data tiles with the highest data similarity in a first array, among a plurality of data tiles of the unfolded input tensor 350.

In one embodiment, the unfolded input tensor 350 may include overlapping elements having the same value duplicated from the same element of the input tensor 310. Data similarity between data tiles may be determined based on how many different data tiles include the same overlapping elements, and there may be another data tile with the highest data similarity based on a certain data tile.

For example, data tiles similar to a first data tile T0 of the unfolded input tensor 350 may include a third data tile T2, a fifth data tile T4, and so on, and among the data tiles, a data tile with the highest data similarity to the first data tile T0 may be the third data tile T2. Also, data tiles similar to the second data tile T1 of the unfolded input tensor 350 may include a fourth data tile T3 and a sixth data tile T5, and among the data tiles, a data tile with the highest data similarity to the second data tile T1 may be the fourth data tile T3.

In this way, there may be another data tile with the highest data similarity to each of a plurality of data tiles constituting the unfolded input tensor 350, and a neural network accelerator may identify a distance between a pair of data tiles with the highest data similarity in the first array, that is, a distance of “2” between the first data tile T0 and the third data tile T2 or between the second data tile T1 and the fourth data tile T3 in the first array, as a tile distance.

In one embodiment, a neural network accelerator may identify a tile distance based on Equation 1 below.

$$tile\_dist = C \times stride / tile\_width \qquad Equation 1$$

Here, “tile_dist” refers to a tile distance, “C” refers to the number of channels of the filter tensor 320, “stride” refers to a stride of the filter tensor 320, and “tile_width” refers to a width of a data tile.

That is, the neural network accelerator may identify a value obtained by dividing another value, which is obtained by multiplying the number of channels of the input tensor 310 by a stride of the filter tensor 320 of a convolution operation, by a width of each of a plurality of data tiles, as the tile distance. For example, the neural network accelerator may identify the tile distance as “2”, which is a value obtained by dividing another value, which is obtained by multiplying 256 that is the number of channels C of the input tensor 310 by 1 that is a stride, by 128 that is a width of a data tile, based on information 360 on a neural network parameter and a size of a data tile. This may mean that each of a plurality of data tiles of the unfolded input tensor 350 has the highest data similarity to data tiles that are away from the plurality of data tiles by “2” in a row direction in a first array.

In one embodiment, a plurality of elements constituting each row of the unfolded input tensor 350 may be arranged in the input tensor 350 in which a plurality of elements of the filter tensor 320 that are element-by-element-multiplied by the filter tensor 320 are selected and unfolded sequentially along a row axis in each step of a convolution operation. In this case, a neural network accelerator may identify a tile distance based on Equation 2 below.

$$tile\_dist = S \times R \times C / tile\_width \qquad Equation 2$$

Here, “R” and “C” may refer to respectively a width and a height of the filter tensor 320.

That is, the neural network accelerator may identify a value obtained by dividing another value, which is obtained by multiplying a width and height of the filter tensor 320 by the number of channels of the input tensor 310, by a size of each of a plurality of data tiles, as the tile distance.

In one embodiment, the neural network accelerator may identify how a plurality of elements of the input tensor 310 that are element-by-element-multiplied by the filter tensor 320 at each step of a convolution operation are arranged and formed.

In one embodiment, when a plurality of elements constituting each row of the unfolded input tensor 350 are identified as a plurality of elements of the input tensor 310 which are element-by-element-multiplied by the filter tensor 320 at each step of a convolution operation and are arranged along a channel axis, a neural network accelerator may identify a value obtained by dividing another value, which is obtained by multiplying the number of channels of the input tensor 310 by a stride of the filter tensor 320 of a convolution operation, by a width of each of a plurality of data tiles, as a tile distance.

In one embodiment, when a plurality of elements constituting each row of the unfolded input tensor 350 are identified as a plurality of elements of the input tensor 310 which are element-by-element-multiplied by the filter tensor 320 at each step of a convolution operation and are arranged along a channel axis, a neural network accelerator may identify a value obtained by dividing another value, which is obtained by multiplying a width and height of the filter tensor 320 by the number of channels of the input tensor 310, by a size of each of a plurality of data tiles, as a tile distance.

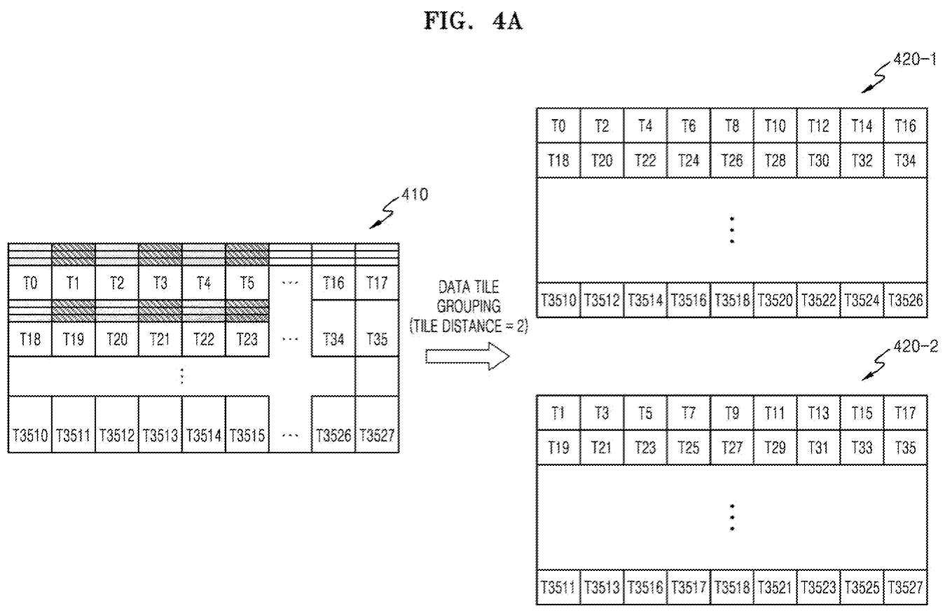

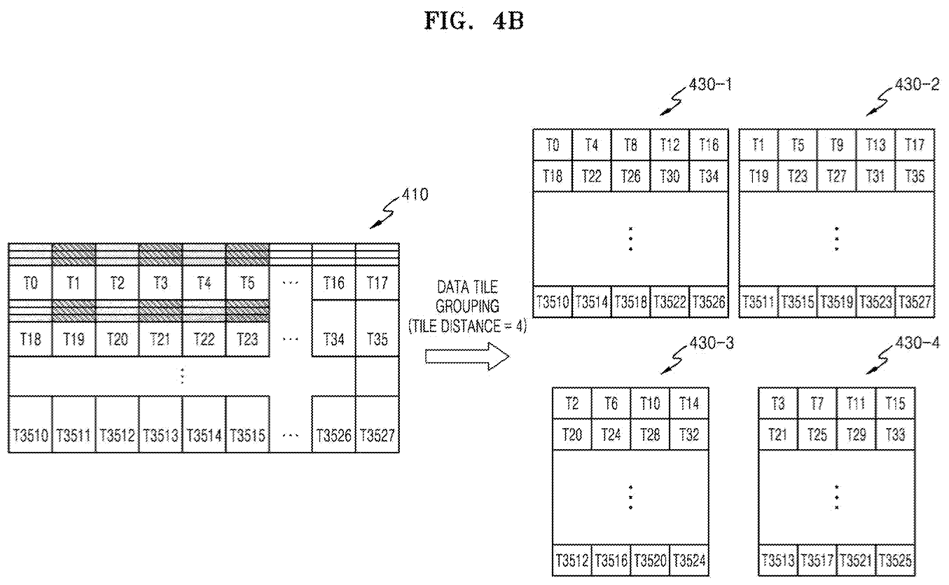

FIGS. 4A and 4B are diagrams illustrating an operation of a neural network accelerator to identify a second array, according to an embodiment. A first array 410 of a plurality of data tiles illustrated in FIGS. 4A and 4B may correspond to the first array of the plurality of data tiles constituting the unfolded input tensor 350 of FIG. 3B.

Referring to FIG. 4A, a neural network accelerator may identify a tile distance as 2. In this case, the neural network accelerator may identify a first group 420-1 and a second group 420-2 which are a plurality of second arrays of a plurality of data tiles by grouping data tiles that are spaced apart by a tile distance of 2 from a first array 410 of a plurality of data tiles.

In one embodiment, data tiles in odd-numbered rows of the first array 410, such as data tiles T0, T18, . . . , T3510 in the first column of the first array 410, data tiles T2, T20, . . . , T3512 in the third column spaced apart by 2 columns in a row direction from the data tiles T0, T18, . . . , T3510 in the first column, and data tiles T4, T22, . . . , T3514 in the fifth column spaced apart by 2 columns in the row direction from the data tiles T2, T20, . . . , T3512 in the third column, may be included in the first group 420-1. That is, the neural network accelerator may identify the first group 420-1 by grouping all data tiles, which are spaced apart by a tile distance of 2 in the row direction into the same group, based on the data tiles T0, T18, . . . , T3510 in the first column of the first array 410.

In one embodiment, data tiles in even-numbered rows in the first array 410, such as data tiles T1, T19, . . . , T3511 in the second column of the first array 410, data tiles T3, T21, . . . , T3513 in the fourth column spaced apart by 2 columns in a row direction from the data tiles T1, T19, . . . , T3511 in the second column, and data tiles T5, T23, . . . , T3515 in the sixth column spaced apart by 2 columns in the row direction from the data tiles T3, T21, . . . , T3513 in the fourth column, may be grouped into the second group 420-2. That is, the neural network accelerator may identify the second group 420-2 by grouping all data tiles, which are spaced apart by a tile distance of 2 in the row direction into the same group, based on the data tiles T1, T19, . . . , T3511 in the second column of the first array 410.

Referring to FIG. 4B, a neural network accelerator may identify a tile distance as 4. In one embodiment, the neural network accelerator may identify a first group 430-1, a second group 430-2, a third group 430-3, and a fourth group 430-4, which are a plurality of second arrays of a plurality of data tiles by grouping data tiles that are spaced apart by a tile distance of 4 from the first array 410 of the plurality of data tiles.

In one embodiment, data tiles in the first column, fifth column, ninth column, 13th column, and 17th column in the first array 410, such as data tiles T0, T18, . . . , T3510 in the first column of the first array 410 and data tiles T4, T22, . . . , T3514 in the fifth column spaced apart by 4 columns in a row direction from the data tiles T0, T18, . . . , T3510 in the first column, may be included in a first group 430-1. That is, the neural network accelerator may identify the first group 430-1 by grouping all data tiles spaced apart by a tile distance of 4 in a row direction into the same group based on the data tiles T0, T18, . . . , T3510 in the first column of the first array 410.

In one embodiment, data tiles in the second column, sixth column, tenth column, 14th column, and 18th column in the first array 410, such as data tiles T5, T23, . . . , T3515 in the sixth column spaced apart by 4 columns in a row direction from the data tiles T1, T19, . . . , T3511 in the second column of the first array 410, may be included in a second group 430-2. That is, the neural network accelerator may identify the second group 430-2 by grouping all data tiles spaced apart by a tile distance of 4 in a row direction into the same group, based on the data tiles T1, T19, . . . , T3511 in the second column of the first array 410.

In one embodiment, data tiles in the third column, seventh column, eleventh column, and 15th column in the first array 410, such as data tiles T6, T24, . . . , T3516 in the seventh column spaced apart by 4 columns in a row direction from the data tiles T2, T20, . . . , T3512 in the third column of the first array 410, may be included in a third group 430-3. That is, the neural network accelerator may identify the third group 430-3 by grouping all data tiles spaced apart by a tile distance of 4 in a row direction into the same group, based on the data tiles T2, T20, . . . , T3512 in the third column of the first array 410.

In one embodiment, data tiles in the fourth column, eighth column, 12th column, and 16th column in the first array 410, such as data tiles T7, T25, . . . , T3517 in the eighth column spaced apart by 4 columns in a row direction from the data tiles T3, T21, . . . , T3513 in the fourth column of the first array 410, may be included in a fourth group 430-4. That is, the neural network accelerator may identify the fourth group 430-4 by grouping all data tiles spaced apart by a tile distance of 4 in a row direction into the same group, based on the data tiles T3, T21, . . . , T3513 in the fourth column of the first array 410.

In this way, a neural network accelerator according to an embodiment may identify a plurality of second arrays by grouping a plurality of data tiles constituting an unfolded input tensor based on a tile distance. Here, because the tile distance is a distance between a pair of data tiles with the highest similarity, a plurality of second arrays, in which data tiles with high similarity are grouped into the same group, may be identified.

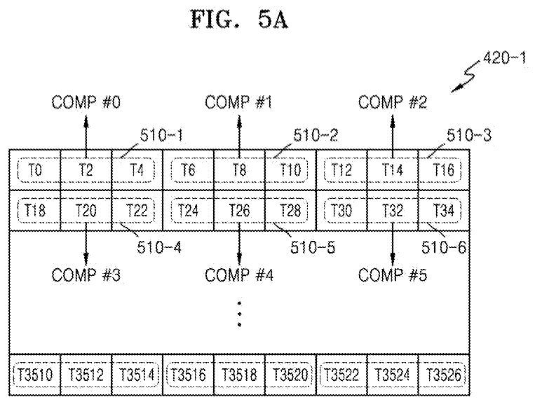

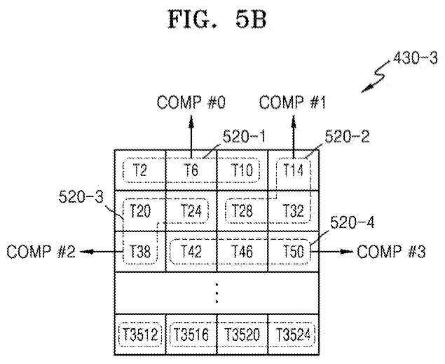

FIGS. 5A and 5B are diagrams illustrating an operation of a neural network accelerator to form a data tile set, according to an embodiment.

Referring to FIG. 5A, the neural network accelerator may form a plurality of data tile sets by grouping data tiles included in a first group 420-1. The first group 420-1 in FIG. 5A is one of the plurality of second arrays identified in FIG. 4A, and a plurality of data tile sets may be formed in the same manner for a second group 420-2 in FIG. 4A.

In one embodiment, the neural network accelerator may form a plurality of data tile sets by grouping adjacent data tiles in the first group 420-1 by a preset number for each group. In one embodiment, the neural network accelerator may group adjacent data tiles in a row direction in the first group 420-1 by a preset number for each group.

For example, when the preset number is 3, the neural network accelerator may form a first data tile set 510-1 by grouping data tiles T0, T2, and T4 respectively in first, second, and third columns of a first row of the first group 420-1, form a second data tile set 510-2 by grouping data tiles T6, T8, and T10 respectively in fourth, fifth, and sixth columns of a first row of the first group 420-1, and form a third data tile set 510-3 by grouping data tiles T12, T14, and T16 respectively in seventh, eighth, and ninth columns of a first row of the first group 420-1. In the same manner, the neural network accelerator may form a fourth data tile set 510-4, a fifth data tile set 510-5, and a sixth data tile set 510-6 by grouping data tiles in a second row by three for each group and form a plurality of data tile sets by grouping data tiles located in the other rows by three for each group.

In one embodiment, the neural network accelerator may allocate a plurality of formed data tile sets to a plurality of components. For example, the first data tile set 510-1 may be allocated to a component #0. In this case, among the data tiles T0, T2, and T4 included in the first data tile set 510-1, the data tile T0 and the data tile T2, and the data tile T2 and the data tile T4 may have the highest data similarity to each other in that the data tile T0 and the data tile T2, and the data tile T2 and the data tile T4 are the closest data tiles among data tiles spaced apart by a tile distance in a row direction in the first array 410 of FIG. 4A.

In this way, by grouping similar data tiles into the same data group and allocating the grouped data tiles to each of a plurality of components, the time and cost required for a plurality of components to access an external memory for a GEMM operation may be reduced.

Referring to FIG. 5B, a neural network accelerator may form a plurality of data tile sets by grouping data tiles included in the third group 430-3. The third group 430-3 in FIG. 5B is one of the plurality of second arrays identified in FIG. 4B, and a plurality of data tile sets may also be formed for a first group 430-1, a second group 430-2, and a fourth group 430-4 in FIG. 4B in the same manner.

In one embodiment, the neural network accelerator may form a plurality of data tile sets by grouping adjacent data tiles in the third group 430-3 by a preset number for each group. In one embodiment, the neural network accelerator may group adjacent data tiles in a row direction in the first group 420-1 by a preset number for each group. At least one ungrouped data tile in a row direction in the first group 420-1 by a preset number for each group and at least one data tile adjacent to the column direction may be added together to be grouped by a preset number for each group.

For example, when the preset number is 3, the neural network accelerator may form the first data tile set 520-1 by grouping the data tiles T2, T6, and T10 in the first, second, and third columns in the first row of the third group 430-3 that may be grouped by three in a row direction, and form the fourth data tile set 520-4 by grouping data tiles T42, T46, and T50 in the second, third, and fourth columns of the third row. In addition, the neural network accelerator may forms the second data tile set 520-2 by grouping the ungrouped data tile T4 in the fourth column of the first row and ungrouped data tiles T28 and T32 in the third and fourth columns of the second row, which are ungrouped by three for each group in the row direction, and may form the third data tile set 520-3 by grouping data tiles T20 and T24 respectively in the first and second columns of the second row and data tile T38 in the first column of the third row.

In one embodiment, the neural network accelerator may allocate a plurality of formed data tile sets to a plurality of components. For example, the second data tile set 520-2 may be allocated to a component #1. In this case, among the data tiles T14, T28, and T32 included in the second data tile set 520-2, the data tile T28 and the data tile T32 may have the highest data similarity to each other in that the data tile T28 and the data tile T32 are spaced apart from each other by a tile distance in the row direction of the first array 410 of FIG. 4A. In addition, the data tile T14 does not have the highest data similarity to the data tile T32 in that the data tile T14 and the data tile T32 are adjacent to each other in the column direction, but the data tile T14 and the data tile T32 may have data similarity to each other in that the data tile T14 and the data tile T32 do not have overlapping elements.

In this way, even when the number of columns in the second array is not an integer multiple of the preset number which is the number of data tiles grouped into a data tile set, similar data tiles may be grouped into the same data tile set and allocated to a plurality of components, and accordingly, the time and cost required for a plurality of components to access an external memory for a GEMM operation may be reduced.

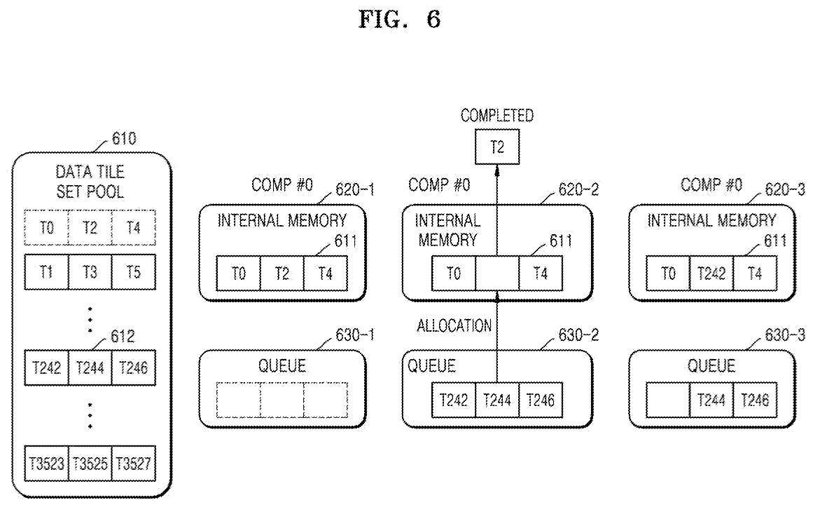

FIG. 6 is a diagram illustrating an operation of a neural network accelerator to allocate a data tile set to a component, according to an embodiment.

Referring to FIG. 6, the neural network accelerator may form a plurality of data tile sets by grouping a plurality of data tiles based on a tile distance. In one embodiment, the plurality of formed data tile sets may be stored in a data tile set pool 610. Among the plurality of data tile sets stored in the data tile set pool 610, a data tile set allocated to a component may be removed from the data tile set pool 610. For example, a first data tile set 611 may be allocated to a component #0 and stored in an internal memory 620-1 of the component #0. In this case, the first data tile set 611 is removed from the data tile set pool 610, and thereby, the other data tile sets excluding the first data tile set 611 may be allocated to a plurality of components.

In one embodiment, the neural network accelerator may identify a component of which queue is empty among a plurality of components and register one of the plurality of data tile sets in the queue of the identified component. For example, after the first data tile set 611 is registered in a queue 630-1 of the component #0, when all data tiles of the first data tile set 611 are allocated to the component #0, the queue 630-1 of the component #0 may be empty. The neural network accelerator may register a second data tile set 612, which is one of the plurality of data tile sets stored in the data tile set pool 610, in the queue 630-1 of the component #0.

In one embodiment, a component may perform a GEMM operation on the allocated data tile. In one embodiment, when a plurality of data tiles are allocated to a component, the component may perform a GEMM operation on each of the plurality of data tiles, and the data tile on which the GEMM operation is completed may be deallocated. For example, as the component #0 performs a GEMM operation on the data tile T2 which is one of the plurality of data tiles included in the first data tile set 611 allocated to the component #0 and deallocates the data tile T2, a space of an internal memory 620-2, to which the data tile T2 is allocated, may be in a reusable state.

In one embodiment, when a GEMM operation on a data tile allocated to a component is completed, the neural network accelerator may allocate a data tile included in a data tile set registered in a queue to the component. For example, when a GEMM operation on the data tile T2 allocated to a component #0 is completed, the neural network accelerator may allocate a data tile T242, which is one of data tiles included in the second data tile set 612 registered in a queue 630-2 of the component #0, to the component #0. When the data tile T242 is allocated to the component #0, the data tile T242 may be stored in an internal memory 620-3 of the component #0, and a GEMM operation on the data tile T242 may be performed. In a similar manner, when a GEMM operation is performed on the data tile T0 and the data tile T4 allocated to the component #0, the data tile T244 and the data tile T246 registered in the queue 630-3 of the component #0 may be allocated to the component #0.

In this way, the neural network accelerator according to an embodiment may register data tiles in the queues of the components in units of set and then allocate the data tiles to components, and accordingly, GEMM operations may be performed together on data tiles allocated to similar components. Accordingly, the time and cost required to access an external memory to store the data tiles allocated to a component in an internal memory may be reduced.

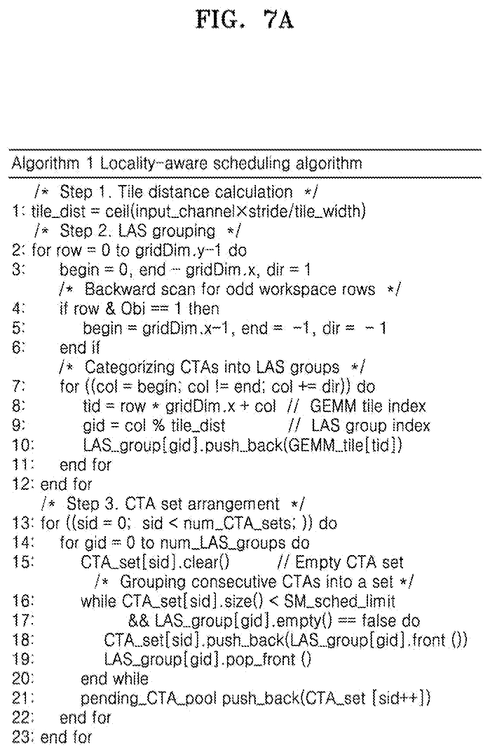

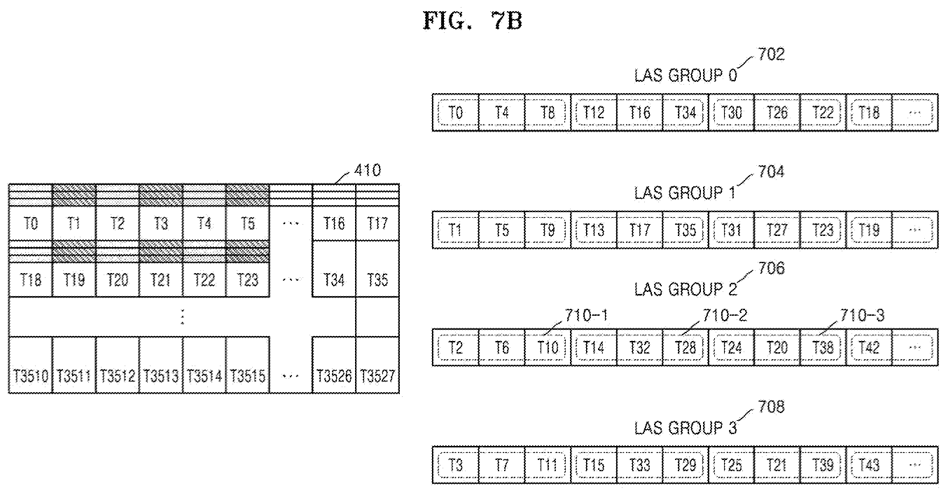

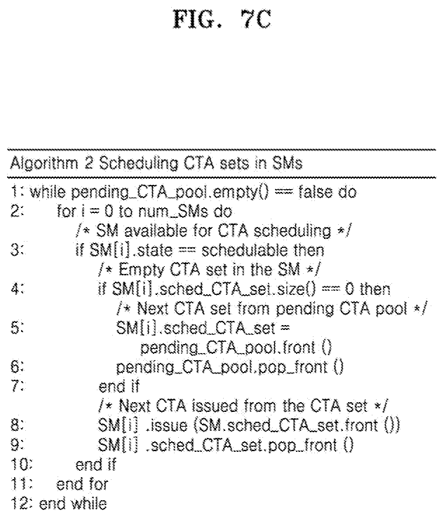

FIG. 7A is pseudocode illustrating an algorithm for forming a data tile set by a neural network accelerator, according to an embodiment. Here, gridDim.x may refer to the number of data tiles in a horizontal direction in a first array among a plurality of data tiles, and gridDim.y may refer to the number of data tiles in a vertical direction among the plurality of data tiles. Additionally, LAS_group may refer to a second array of a plurality of data tiles, GEMM_tile may refer to a data tile, and CTA_set may refer to a data tile set.

Referring to line 1 of FIG. 7A, the neural network accelerator may identify a tile distance tile_dist by a value obtained by dividing another value, which is obtained by multiplying the number of channels input_channel of an input tensor by a stride of a filter tensor, by a width tile_width of a plurality of data tiles.

Referring to line 2 to line 12 of FIG. 7A, the neural network accelerator increases a row index from 0 in a first array, scan a plurality of data tiles included in the same row, and group the plurality of data tiles. The neural network accelerator may change a direction in which the plurality of data tiles are scanned whenever the row index row of the plurality of data tiles increases. For example, a neural network accelerator may scan the plurality of data tiles in a direction in which a column index increases when the row index is an even number, and scan the plurality of data tiles in a direction in which the column index decreases when the row index is an odd number. The neural network accelerator may scan the plurality of data tiles for each row of the first array, and include the plurality of data tiles in one of a plurality of LAS_groups based on a value obtained by dividing a column index col of the plurality of data tiles by a tile distance tile_dist, and thereby, data tiles spaced apart from each other by a tile distance in the first array may be included in the same LAS_group. Accordingly, the neural network accelerator may identify a plurality of LAS_groups, each having a plurality of grouped data tiles.

Referring to line 13 to line 23 of FIG. 7A, the neural network accelerator may form a plurality of CTA_sets by grouping a plurality of data tiles included in each of the plurality of LAS_groups. When a size of CTA_set is smaller than the number of data tiles SM_sched_limit that may be allocated to a plurality of components and Las_group is not empty, the neural network accelerator may take GEMM_tiles included in the corresponding LAS_group sequentially from the beginning and add the GEMM_tiles to CTA_set, and the added GEEM_tiles may be removed from LAS_group. Accordingly, the neural network accelerator may form a plurality of CTA_sets by grouping adjacent data tiles in each of the plurality of LAS_groups by a preset number for each group.

FIG. 7B is a diagram illustrating a second array of a plurality of data tiles identified by a neural network accelerator while switching a scan direction, according to an embodiment. Locality-aware scheduling (LAS) group 0 702, LAS group 1 704, LAS group 2 706, and LAS group 3 708 of FIG. 7B may respectively correspond to a plurality of second arrays identified when a tile distance is 4 in the first array 410 of FIG. 4B according to the pseudocode illustrated in FIG. 7A.

Referring to FIG. 7B, the neural network accelerator may switch a direction in which a plurality of data tiles are scanned whenever a row index of the plurality of data tiles of the first array 410 increases according to the pseudocode of FIG. 7A, and may identify a plurality of LAS groups by grouping data tiles spaced apart by a tile distance.

For example, the neural network accelerator may perform scanning in a right direction in a first row of the first array 410, group data tiles spaced apart by a tile distance into LAS group 0 702 based on the data tile T0, group data tiles spaced apart by the tile distance into LAS group 1 704 based on the data tile T1, group data tiles spaced apart by the tile distance into LAS group 2 706 based on the data tile T2, and group data tiles spaced apart by the tile distance into LAS group 3 708 based on the data tile T3.

Also, the neural network accelerator may perform scanning in a left direction in a second row of the first array 410, group data tiles spaced apart by a tile distance into LAS group 0 702 based on the data tile T34, group data tiles spaced apart by the tile distance into LAS group 1 704 based on the data tile T35, group data tiles spaced apart by the tile distance into LAS group 2 706 based on the data tile T32, and group data tiles spaced apart by the tile distance into LAS group 3 708 based on the data tile T33.

In one embodiment, the neural network accelerator may form a plurality of data tile sets by grouping adjacent data tiles included in each of a plurality of LAS groups by a preset number for each group. For example, when the preset number is 3, the neural network accelerator may form a first data tile set 710-1, a second data tile set 710-2, and a third data tile set 710-3 by grouping adjacent data tiles in LAS group 2 by 3 data tiles for each group. Here, the first data tile set 710-1 may correspond to the first data tile set 520-1 in FIG. 5B, the second data tile set 710-2 may correspond to the second data tile set 520-2 in FIG. 5B, and the third data tile set 710-3 may correspond to the third data tile set 510-3 in FIG. 5B.

In this way, the neural network accelerator according to an embodiment may switch a scan direction of a plurality of data tiles for each row in the first array 410 and a plurality of one-dimensional second arrays by grouping a plurality of data tiles. In addition, the neural network accelerator forms a plurality of data tile sets from a plurality of one-dimensional second arrays, thereby forming a plurality of data tile sets by grouping together at least one data tile that is not grouped by a preset number for each group in a row direction in the plurality of second two-dimensional arrays illustrated in FIGS. 5A and 5B and at least one data tile adjacent to at least one ungrouped data tile in a column direction, by a preset number for each group.

FIG. 7C is pseudocode illustrating an algorithm for allocating data tile sets to a plurality of components by a neural network accelerator, according to an embodiment. Here, a streaming multiprocessor (SM) may correspond to a component of the neural network accelerator.

Referring to line 3 of FIG. 7C, the neural network accelerator may identify whether each of the plurality of SMs may be scheduled. The fact that the plurality of SMs may perform scheduling may mean that a GEMM operation on data tiles is completed by each SM and a new data tile may be allocated. Referring to line 4 to line 6, when a size of CTA_set scheduled in the SM is 0, the neural network accelerator may register CTA_set at the front of pending_CTA_pool in a queue of an SM and remove CTA_set registered in the queue from pending_CTA_pool. Referring to line 7 to line 9, when the size of the scheduled CTA_set is not 0, the neural network accelerator may allocate the data tile at the front of CTA_set registered in the queue of the SM to the SM and remove the allocated data tile from CTA_set.

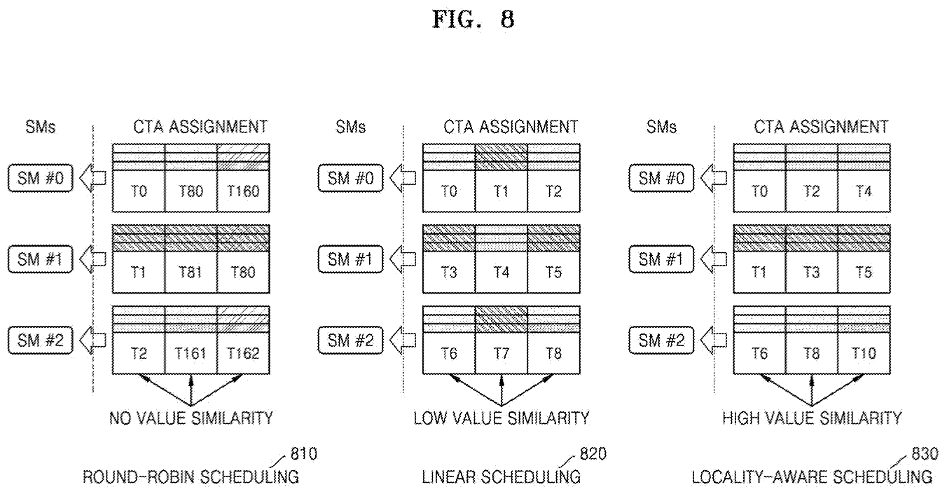

FIG. 8 is a diagram illustrating the similarity of data tiles allocated to a component according to scheduling of a neural network accelerator according to an embodiment.

Referring to FIG. 8, a plurality of data tiles may be allocated to a plurality of SMs through scheduling. Here, the plurality of SMs are only an example of a component of the neural network accelerator according to the disclosure, and the disclosure is not limited thereto. Also, LAS 830 refers to scheduling of a neural network accelerator according to an embodiment, and round-robin scheduling 810 and linear scheduling 820 are illustrated as a scheduling method contrasting thereto. In FIG. 8, it is assumed that a tile distance is 2.

When data tiles are allocated to a plurality of SMs according to the round-robin scheduling 810, there is no data similarity between data tiles included in an allocated data tile set. For example, a data tile set including a data tile T0, a data tile T80, and a data tile T160 may be allocated to SM #0. In this case, there may be no data similarity between the data tiles included in the data tile set in that the tile distance is 2. Accordingly, the round-robin scheduling 810 may provide the lowest L1 cache hit rate.

When data tiles are allocated to a plurality of SMs according to the linear scheduling 820, there may be data similarity between some of the data tiles included in the allocated data tile set. For example, a data tile set including a data tile T0, a data tile T1, and a data tile T2 may be allocated to SM #0. In this case, there may be data similarity between the data tile T0 and the data tile T2 in that the tile distance is 2. However, there is no data similarity between the data tile T1, the data tile T0, and the data tile T2, and when the tile distance is 3 or more, data tile sets including data tiles with no data similarity may be allocated to a plurality of SMs. Accordingly, the linear scheduling 810 may provide a higher L1 cache hit rate than the round-robin scheduling 820.

When data tile sets are allocated to a plurality of SMs according to the LAS scheduling 830, there may be data similarity between all data tiles included in the allocated data tile set. For example, a data tile set including the data tile T0, the data tile T2, and the data tile T4 may be allocated to the SM #0. In this case, there may be data similarity between each of the data tile T0, the data tile T2, and the data tile T4 and other data tiles in that the tile distance is 2. Accordingly, the LAS scheduling 830 may provide the highest L1 cache hit rate than other scheduling methods.

In this way, a neural network accelerator according to an embodiment may obtain a higher L1 cache hit rate than other scheduling methods by allocating a data tile set including data tiles with high data similarity to a plurality of components.

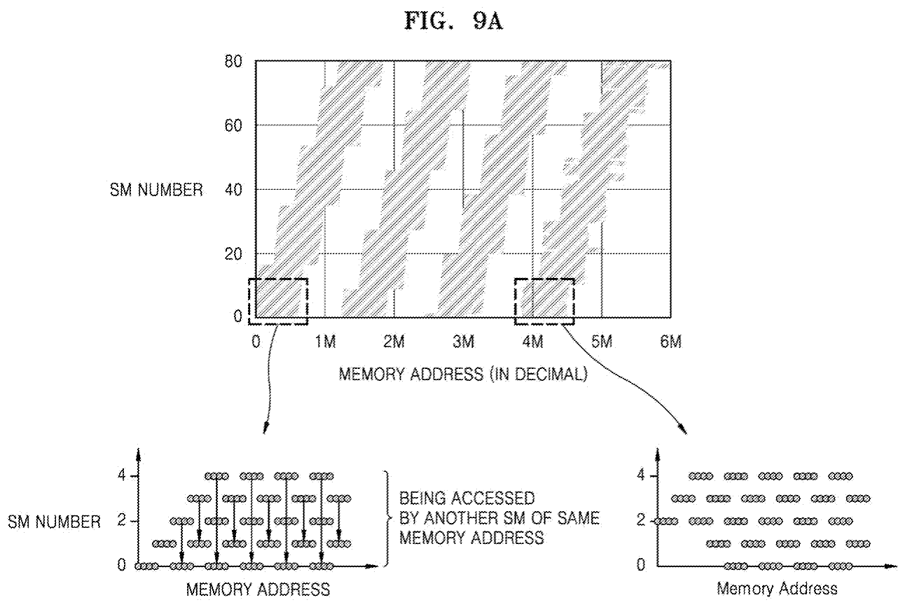

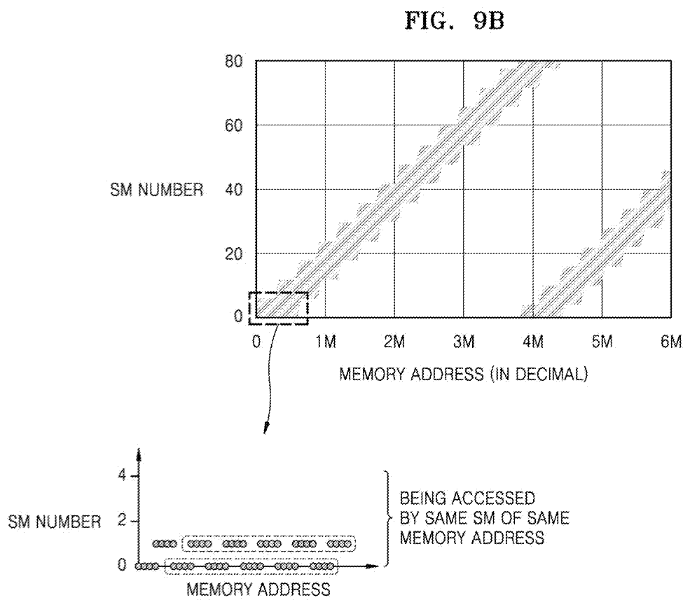

FIGS. 9A and 9B are diagrams illustrating memory addresses accessed by components according to scheduling of a neural network accelerator according to an embodiment. FIG. 9A illustrates memory addresses accessed by a plurality of SMs as data tiles are allocated to a plurality of SMs according to round-robin scheduling. Also, FIG. 9B illustrates memory addresses accessed by a plurality of SMs by allocating data tiles to the plurality of SMs according to LAS scheduling, which is a scheduling method of a neural network accelerator, according to an embodiment.

Referring to FIG. 9A, when data tiles are allocated to a plurality of SMs according to the round-robin scheduling, the same memory address may be accessed by other SMs while performing a GEMM operation on the data tiles allocated to the plurality of SMs. That is, similar data tiles may be allocated to different SMs in that the round-robin scheduling allocates the data tiles to a plurality of SMs without considering data similarity. Accordingly, an address of an external memory where the same overlapping elements included in similar data tiles are stored may be accessed by different SMs.

For example, the same overlapping elements may be included in a data tile allocated to SM #0 and a data tile allocated to SM #2. In this case, in order to store the overlapping elements in an internal memory, both SM #0 and SM #2 access an address of a memory where the overlapping elements are stored. In this way, when different SMs access the same memory address and respectively load overlapping elements to perform an operation, unnecessary access costs are required.

In addition, when data tiles are allocated to a plurality of SMs according to the round-robin scheduling, whenever a GEMM operation on a data tile is completed by an SM, a next data tile set stored in a data tile set pool is allocated to a corresponding SM. Accordingly, the scheduling order of a plurality of SMs and a corresponding memory access order may be reversed.

Referring to FIG. 9B, when data tiles are allocated to a plurality of SMs according to the LAS scheduling, the same memory address may be accessed by the same SM while performing a GEMM operation on the data tiles allocated to the plurality of SMs That is, similar data tiles may be allocated to the same SM in that data tiles are allocated to a plurality of SMs by considering data similarity in the LAS scheduling. Accordingly, an address of an external memory, in which the same overlapping elements included in similar data tiles are stored, may be accessed by the same SM.

FIG. 10 is a diagram illustrating a detailed configuration of a neural network accelerator according to an embodiment. Referring to FIG. 10, a neural network accelerator 1000 may include a component 1100, a memory 1200, and at least one processor 1300. The component 1100, the memory 1200, and at least one processor 1300 may be electrically and/or physically connected to each other.

The components illustrated in FIG. 10 are merely examples, and components included in the neural network accelerator 1000 are not limited to the components illustrated in FIG. 10. The neural network accelerator 1000 according to an embodiment may not include some of the components illustrated in FIG. 10 and may further include components not illustrated in FIG. 10.

The component 1100 may be configured to perform a convolution operation on neural network data. In one embodiment, the component 1100 may include a plurality of components for processing a convolution operation on neural network data in parallel. For example, the plurality of components may correspond to a plurality of SMs of a graphics processing unit (GPU), a plurality of cores of a central processing unit (CPU), or a plurality of processing elements (PE) of a neural processing unit (NPU), and are not limited to example described above. In one embodiment, the component 1100 may include an internal memory for storing neural network data and a plurality of operation units 1110 for performing a convolution operation on the neural network data.

The memory 1200 may store instructions, data structures, and program codes that may be read by the processor 1300. In the disclosed embodiments, operations performed by the processor 1300 may be implemented by executing instructions or codes of a program stored in the memory 1200.

The memory 1200 may be non-volatile memory including at least one of a flash memory type, a hard disk type, a multimedia card micro type, a card type memory (for example, secure digital (SD), extreme digital (XD) memory, or so on), read-only memory (ROM), electrically erasable programmable read-only memory (EEPROM), programmable read-only memory (PROM), magnetic memory, magnetic disk, and an optical disk, and volatile memory, such as random access memory (RAM) or static random access memory (SRAM).

In one embodiment, the memory 1200 may store data used or necessary for scheduling of a neural network accelerator according to various embodiments. For example, the memory 1200 may store an input tensor, a filter tensor, and an output tensor on which a convolution operation is performed. The input tensor, filter tensor, and output tensor stored in the memory 1200 may be transmitted to the component 1100 in units of data tiles according to scheduling of the neural network accelerator 1000. Also, the memory 1200 may store information on neural network parameters, information on data tiles, information on a first array of a plurality of data tiles, information on a second array of a plurality of data tiles, and information on a plurality of data tile sets. Also, the memory 1200 may store at least one module for performing the algorithms illustrated in FIGS. 7A and 7C. However, the disclosure is not limited to the example described above, and information for performing an operation of the neural network accelerator 1000 disclosed in various embodiments may be stored in the memory 1200.

The processor 1300 may execute one or more instructions of a program stored in the memory 1200. The at least one processor 1300 may be configured with hardware components that perform arithmetic, logic, input/output operations, and signal processing. The at least one processor 1300 may include at least one of, for example, a CPU, a microprocessor, a GPU, application specific integrated circuits (ASICs), digital signal processors (DSPs), digital signal processing devices (DSPDs), programmable logic devices (PLDs), and field programmable gate arrays (FPGAs) but is not limited thereto.

In one embodiment, the at least one processor 1300 may identify a first array of a plurality of data tiles constituting an unfolded input tensor obtained by unfolding the input tensor to perform a convolution operation by using a GEMM operation.

In one embodiment, the at least one processor 1300 may identify a tile distance representing a distance between a pair of data tiles with the highest data similarity among a plurality of data tiles in a first array.

In one embodiment, the at least one processor 1300 may form a plurality of data tile sets by grouping a plurality of data tiles based on a tile distance.

In one embodiment, the at least one processor 1300 may allocate a plurality of data tile sets to a plurality of components that process GEMM operations in parallel.

In one embodiment, an unfolded input tensor may be a two-dimensional tensor obtained based on arranging a plurality of elements of the input tensor, on which element-by-element multiplication is performed at each step of a convolution operation, as elements of each row of the unfolded input tensor.

In one embodiment, the at least one processor 1300 may identify a value obtained by dividing another value, which is obtained by multiplying the number of channels of an input tensor by a stride of a filter tensor of a convolution operation, by a width of a plurality of data tiles, as a tile distance.

In one embodiment, the at least one processor 1300 may identify a plurality of second arrays of a plurality of data tiles by grouping data tiles spaced apart by a tile distance from a first array.

In one embodiment, the at least one processor 1300 may form a plurality of data tile sets by grouping data tiles included in each of the plurality of second arrays.

In one embodiment, the at least one processor 1300 may form a plurality of data tile sets by grouping adjacent data tiles in each of the plurality of second arrays by a preset number for each group.

In one embodiment, at least one processor 1300 may group adjacent data tiles in a row direction in each of the plurality of second arrays by a preset number for each group.

In one embodiment, the at least one processor 1300 may group, by a preset number for each group, the data tiles which are obtained by adding at least one data tile that is not grouped by the preset number in a row direction in each of the plurality of second arrays to at least one data tile adjacent to the ungrouped data tiles in a column direction.

In one embodiment, the at least one processor 1300 may identify a component of which queue is empty among a plurality of components.

In one embodiment, the at least one processor 1300 may register one of a plurality of data tile sets in a queue of an identified component.

In one embodiment, when a GEMM operation on a data tile allocated to an identified component is completed, the at least one processor 1300 may allocate a data tile included in a registered data tile set to the identified component.

In one embodiment, the preset number may be determined based on the number of data tiles that may be simultaneously allocated to each of a plurality of components.

In one embodiment, the at least one processor 1300 may perform operations and functions of the neural network accelerator 1000 disclosed in various embodiments of the present specification including the embodiments described above, and redundant descriptions thereof are omitted.

According to one embodiment, when performing a convolution operation by using an implicit GEMM method, the neural network accelerator 1000 may group data tiles with high data similarity and allocate the grouped data tiles to the plurality of components 1100. In this way, a scheduling method of grouping similar data tiles with high data similarity and allocating the grouped similar data tiles to the plurality of components 1100 may be referred to as LAS. Because the data tiles grouped through LAS include many identical overlapping elements generated by being duplicated from the same element, utilization of cache memories of the plurality of components 1100 may be increased. Also, because dependence of the plurality of components 1100 on sizes of the cache memories is reduced, a size of a main memory of the plurality of components 1100 may be increased. Accordingly, parallel processing performance by the plurality of components 1100 may be increased.

The above description of the disclosure is provided to enable any person skilled in the art to make or use the disclosure. Various modifications of the disclosure are readily apparent to those skilled in the art, and the general principles defined herein may also be applied to the various modifications without departing from the idea or scope of the disclosure. Accordingly, the disclosure is not intended to be limited to the examples described herein but is to give the widest scope applicable to the principles and novel features disclosed herein.

Although example implementations may refer to utilization of aspects of the presently disclosed subject matters in the context of one or more standalone computer systems, the subject matter is not so limited and may be implemented in conjunction with any computing environment, such as a network or a distributed computing environment. Furthermore, aspects of the presently disclosed subject matter may be implemented by multiple processing chips or devices, and a storage may be similarly affected by the multiple devices. The devices may also include personal computers (PCs), network servers, and handheld devices.

In addition, embodiments may also be implemented in the form of a recording medium including instructions executable by a computer, such as a program module executed by a computer. A Computer-readable medium may be any available medium that may be accessed by a computer and include both volatile and non-volatile media, removable and non-removable media. Also, computer-readable media may include computer storage media and communication media. The computer storage media includes both volatile and non-volatile media and removable and non-removable media implemented by any method or technology for storing information, such as computer-readable instructions, data structures, program modules, or other types of data. Communication media may include computer readable instructions, data structures, or other types of data of modulated data signals, such as program modules.

Also, computer-readable storage media may be provided in the form of non-transitory storage media. Here, “non-transitory storage media” is a tangible device and simply means not including signals (for example, electromagnetic waves), and the term does not distinguish between a case where data is semi-permanently stored in a storage medium and a case where data is temporarily stored in a storage medium. For example, “non-transitory storage media” may include a buffer where data is temporarily stored.

According to one embodiment, methods according to various embodiments disclosed in the disclosure may be included in a computer program product. The computer program product is commodity and may be traded between a seller and a buyer. The computer program product may be distributed in the form of a machine-readable storage medium (for example, a compact disc read only memory (CD-ROM)) or may be distributed (for example, downloaded or uploaded) directly or online through an application store or between two user devices (for example, smartphones). In the case of online distribution, at least a part of the computer program product (for example, a downloadable app) may be temporarily stored on a machine-readable storage medium, such as a server of an application store or a memory of a relay server or may be generated temporarily.

Although the disclosure is described in relation to some embodiments in the specification, it should be noted that various modifications and changes may be made without departing from the scope of the disclosure and may be understood by those skilled in the art. Also, such modifications and changes should be considered to fall within the scope of the claims appended hereto.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A scheduling method of a neural network accelerator, the scheduling method comprising:
identifying a first array of a plurality of data tiles constituting an unfolded input tensor obtained by unfolding an input tensor to perform a convolution operation by using a general matrix multiplication (GEMM) operation;
identifying a tile distance indicating a distance between a pair of data tiles with highest data similarity among the plurality of data tiles in the first array;
forming a plurality of data tile sets by grouping the plurality of data tiles based on the tile distance; and
allocating the plurality of data tile sets to a plurality of components that process the general matrix multiplication operation in parallel.

2. The scheduling method of claim 1, wherein the unfolded input tensor is a two-dimensional tensor obtained based on arranging a plurality of elements of the input tensor, on which element-by-element multiplication is performed at each step of the convolution operation, as elements of each row of the unfolded input tensor.

3. The scheduling method of claim 1, wherein the identifying of the tile distance includes identifying the tile distance by a value obtained by dividing a second value, which is obtained by multiplying a number of channels of the input tensor by a stride of a filter tensor of the convolution operation, by a width of the plurality of data tiles.

4. The scheduling method of claim 1, wherein the forming of the plurality of data tile sets includes:
identifying a plurality of second arrays of the plurality of data tiles by grouping data tiles spaced apart from the first array by the tile distance; and
forming the plurality of data tile sets by grouping data tiles included in each of the plurality of second arrays.

5. The scheduling method of claim 4, wherein the identifying of the plurality of data tile sets includes forming a plurality of data tile sets by grouping adjacent data tiles in each of the plurality of second arrays by a preset number for each group.

6. The scheduling method of claim 5, wherein the forming of the plurality of data tile sets by grouping the adjacent data tiles by the preset number for each group includes:
grouping adjacent data tiles in a row direction in each of the plurality of second arrays by a preset number for each group; and
grouping, by the preset number for each group, data tiles obtained by adding at least one ungrouped data tile by the preset number in a row direction in each of the plurality of second arrays to at least one data tile adjacent to the at least one ungrouped data tile in a column direction.

7. The scheduling method of claim 6, wherein the allocating of the plurality of data tile sets to the plurality of components includes:
identifying a component of which queue is empty among the plurality of components;
registering one of the plurality of data tile sets in a queue of the identified component; and
allocating a data tile included in the registered data tile set to the identified component when the general matrix multiplication operation on a data tile allocated to the identified component is completed.

8. The scheduling method of claim 5, wherein the preset number is determined based on a number of data tiles capable of being simultaneously allocated to each of the plurality of components.

9. A neural network accelerator comprising:
a memory storing at least one instruction; and
at least one processor configured to execute the at least one instruction stored in the memory,
wherein the at least one processor is further configured to execute the at least one instruction to:
identify a first array of a plurality of data tiles constituting an unfolded input tensor obtained by unfolding an input tensor to perform a convolution operation by using a general matrix multiplication (GEMM) operation;
identify a tile distance indicating a distance between a pair of data tiles with highest data similarity among the plurality of data tiles in the first array;
form a plurality of data tile sets by grouping the plurality of data tiles based on the tile distance; and
allocate the plurality of data tile sets to a plurality of components that process the general matrix multiplication operation in parallel.

10. The neural network accelerator of claim 9, wherein the unfolded input tensor is a two-dimensional tensor obtained based on arranging a plurality of elements of the input tensor, on which element-by-element multiplication is performed at each step of the convolution operation, as elements of each row of the unfolded input tensor.

11. The neural network accelerator of claim 9, wherein the at least one processor is further configured to identify the tile distance by a value obtained by dividing a second value, which is obtained by multiplying a number of channels of the input tensor by a stride of a filter tensor of the convolution operation, by a width of the plurality of data tiles.

12. The neural network accelerator of claim 9, wherein the at least one processor is further configured to:
identify a plurality of second arrays of the plurality of data tiles by grouping data tiles spaced apart from the first array by the tile distance; and
form the plurality of data tile sets by grouping data tiles included in each of the plurality of second arrays.

13. The neural network accelerator of claim 12, wherein the at least one processor is further configured to form a plurality of data tile sets by grouping adjacent data tiles in each of the plurality of second arrays by a preset number for each group.

14. The neural network accelerator of claim 13, wherein the at least one processor is further configured to:
group adjacent data tiles in a row direction in each of the plurality of second arrays by a preset number for each group; and
group, by the preset number for each group, data tiles obtained by adding at least one ungrouped data tile by the preset number in a row direction in each of the plurality of second arrays to at least one data tile adjacent to the at least one ungrouped data tile in a column direction.

15. The neural network accelerator of claim 9, wherein the at least one processor is further configured to:
identify a component of which queue is empty among the plurality of components;
register one of the plurality of data tile sets in a queue of the identified component; and
allocate a data tile included in the registered data tile set to the identified component when the general matrix multiplication operation on a data tile allocated to the identified component is completed.

16. The neural network accelerator of claim 13, wherein the preset number is determined based on a number of data tiles capable of being simultaneously allocated to each of the plurality of components.

17. A computer-readable recording medium on which a program for performing a control method of a neural network accelerator by a computer is recorded, the control method comprising:
identifying a first array of a plurality of data tiles constituting an unfolded input tensor obtained by unfolding an input tensor to perform a convolution operation by using a general matrix multiplication (GEMM) operation;
identifying a tile distance indicating a distance between a pair of data tiles with highest data similarity among the plurality of data tiles in the first array;
forming a plurality of data tile sets by grouping the plurality of data tiles based on the tile distance; and
allocating the plurality of data tile sets to a plurality of components that process the general matrix multiplication operation in parallel.
